(19) United States
(12) Patent Application Publication
(10) Pub. No.: US 2010/0115814 A1
(43) Pub. Date: May 13, 2010

(54) Printed piece including adhesive that enhances distribution and functionality for printed doorhangers

(76) Inventor: Roth K. Christopherson, Wichita, KS (US)

Correspondence Address: ROTH K. CHRISTOPHERSON, 12705 E. Birchwood, Wichita, KS, 67206, US

(21) Appl. No.: 12/590,539

(22) Filed: Nov. 10, 2009

Related U.S. Application Data
(60) Provisional application No. 61/113,106, filed on Nov. 10, 2008.

(51) Int. Cl. G09F 3/10

(52) U.S. Cl. 40/675; 40/594

(57) ABSTRACT

An advertising piece and presentation article printed on a material of any size, weight, thickness or color that has a first planar and a second planar surface. First and second planar surface includes information about one or more advertisers, products, or services, one coupon or a plurality of coupons. Second planar surface includes a strip of adhesive covered by a liner. Liner has three different methods in which it is peeled back to expose the adhesive. The adhesive is used to attach advertising piece and presentation article to door or entryway. Consumer then transfers the article to the inside of building and attaches to any surface, such as a refrigerator, so it is displayed in the view of the consumer.

### CROSS-REFERENCE TO RELATED APPLICATION

This application claims the benefit of provisional patent application No. 61/113,106 filed 2008 Nov. 10 by the present inventor.

### PRIOR ART

The following is a tabulation of some prior art that presently appears relevant:

| PATENT | U.S. Patents Issue Date | Patentee |
|---|---|---|
| 5,458,282 | October 1995 | Martin |
| 6,228,451 | May 2001 | True Label, Inc. |

### BACKGROUND

This invention pertains to an advertising piece and presentation article that is provided to those who advertise as a replacement for die cut doorhangers. The current die cut doorhangers need improvement due to the nature of their design and application inadequacies. The hole and slit style that makes up the die cut doorhanger was originally developed to fit the old fashioned, round doorknobs. These worked fairly well until the storm door industry came out with several new designs of doorknobs and levers causing the die cut doorhanger to easily blow off, fall off or not attach at all. Advertisers are wasting money on these pieces that will potentially become litter in their customers' lawns, not only frustrating the advertiser but aggravating and irritating the customers as well. The distributor also faces aggravation and wastes time struggling to attach a doorhanger to a knob that simply won't accept that design.

Our invention not only resolves the problems described above but also enhances the doorhanger in its functionality and flexibility. Our doorhanger includes an adhesive strip, in place of the hole and slit, which is a more efficient and effective option to utilize during distribution. The adhesive allows the doorhanger to be attached to a wide variety of doorknobs and levers, as well as various places within the entryway, and will not easily fall or blow off.

Our invention allows the advertiser an efficient more effective option because our doorhanger can easily be repositioned from the entryway to the inside of the home. This allows it to take on characteristics similar to a magnet and be displayed in the view of the consumer instead of ending up in a drawer with other competitors ads; however, the adhesive allows it to be positioned on both magnetic and non-magnetic surfaces.

### SUMMARY

The advertising piece and presentation article is enhanced with an adhesive strip which creates a more efficient and effective method to adhere the piece to doors and entryways. The use of adhesive and liner on an advertising piece or presentation article will enhance distribution and usage by presenting information to customers in such a manner that will greatly improve redemption for advertisers. The adhesive may be attached to a wide variety of doorknobs and levers, as well as various places within the entryway and will not easily blow off.

In a further embodiment, the liner has three methods of exposing the adhesive which increases its functionality.

In one embodiment the consumer may transport the advertising piece from the door to the inside of the building and attach to a surface where it will stay in view, such as a refrigerator, instead of in the drawer out of site with the competitors ads.

Drawings- Reference Numerals

| | |
|---|---|
| 2 | hanger |
| 3 | first planar surface |
| 4 | second planar surface |
| 6 | liner covering adhesive |
| 7 | split liner covering adhesive |
| 10 | coupons |
| 11 | adhesive |
| 12 | pad of coupons |
| 14 | door |
| 15 | refrigerator |
| 16 | perforations |

### DESCRIPTION OF THE DRAWINGS

FIG. 1 is a front view of a first planer surface of the advertising piece incorporating features of the present invention.

FIG. 2 is a back view of the first planer surface of the article of FIG. 1.

FIG. 3 is a side edge view of the article of FIG. 1.

FIG. 4 is a side edge view of a further embodiment of the present invention including a split liner.

FIG. 5 is the same edge view of FIG. 3 with liner removed and adhesive completely exposed.

FIG. 6 is a back view of FIG. 3 after peeling and folding liner partially or half way back to expose adhesive.

FIG. 7 is a side edge view of FIG. 4 after a top or bottom part of the split liner has been peeled off to expose adhesive.

FIG. 8 is a side edge view of article in accordance with this invention positioned on a surface such as a door or door entryway.

FIG. 9 is a front view of FIG. 8.

FIG. 10 is a front view of article in accordance with this invention being attached to a surface inside building such as a refrigerator.

FIG. 11 is a side edge view of another embodiment of this invention with layers of multiple coupons incorporating features of the present invention.

FIG. 12 is the same edge view of FIG. 11 with the liner removed to expose adhesive.

FIG. 13 is a side edge view of article in accordance with the invention positioned on a surface such as a door or door entryway.

FIG. 14 is a front view of FIG. 13.

FIG. 15 is a front view of article in accordance with this invention being attached to a surface inside building such as a refrigerator.

### PREFERRED EMBODIMENTS

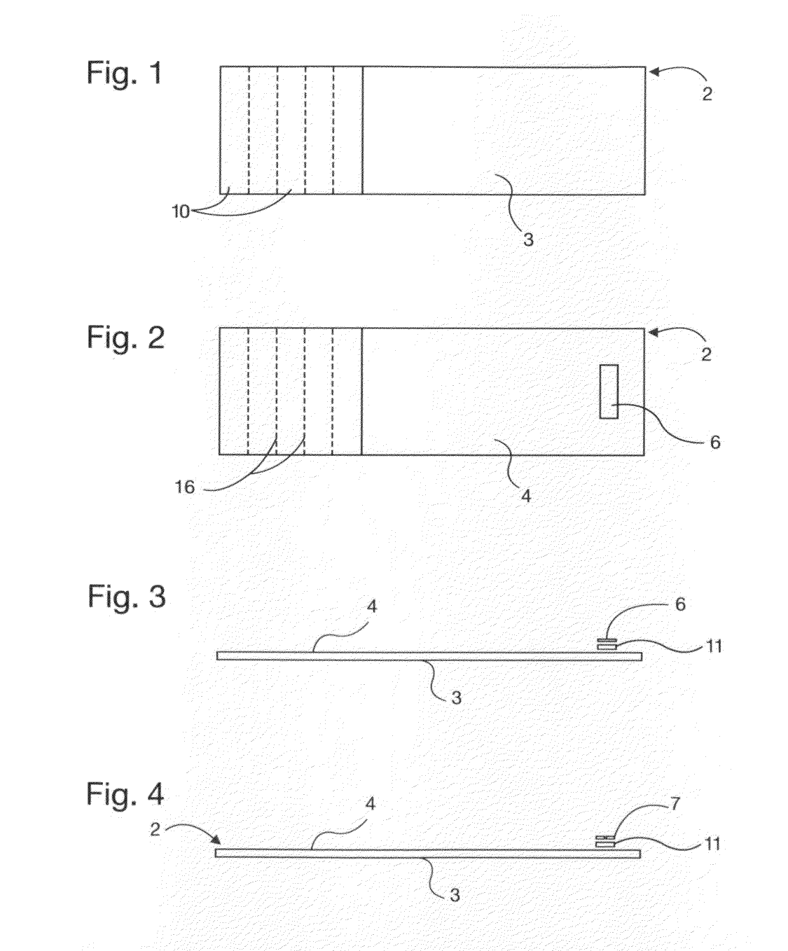

FIG. 1 shows an advertising piece and presentation article as hanger 2 made of a material or paper of any size, weight, thickness or color having a first planar surface 3 which can be dedicated to the presentation of information about one or more advertisers, products or services. Said advertisement can have one coupon or plurality of coupons 10 which may or may not have delineations or perforations 16.

FIG. 2 shows a second planar surface 4 which is the back of hanger 2. This second planar surface 4 also may contain information about one or more advertisers, products or services, one coupon or a plurality of coupons 10 with or without delineations or perforations 16. Coupons 10 can be presented to consumer through multiple layers, such as a pad 12, shown in FIG. 11. Second planar surface 4 includes a strip of adhesive 11 covered by a liner 6, shown in FIG. 3.

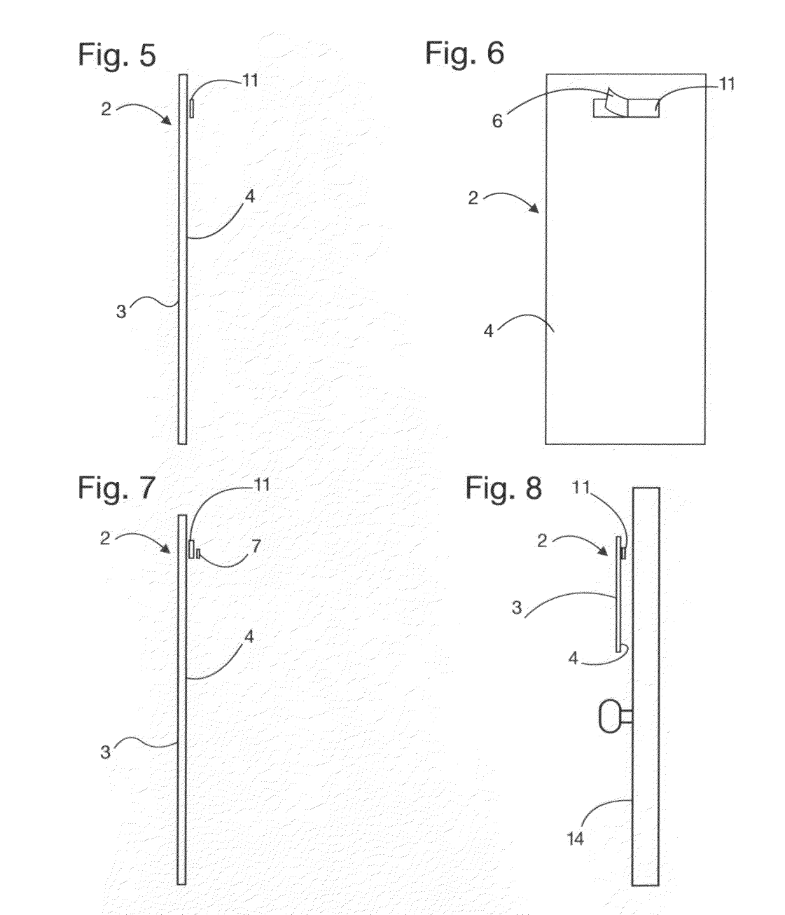

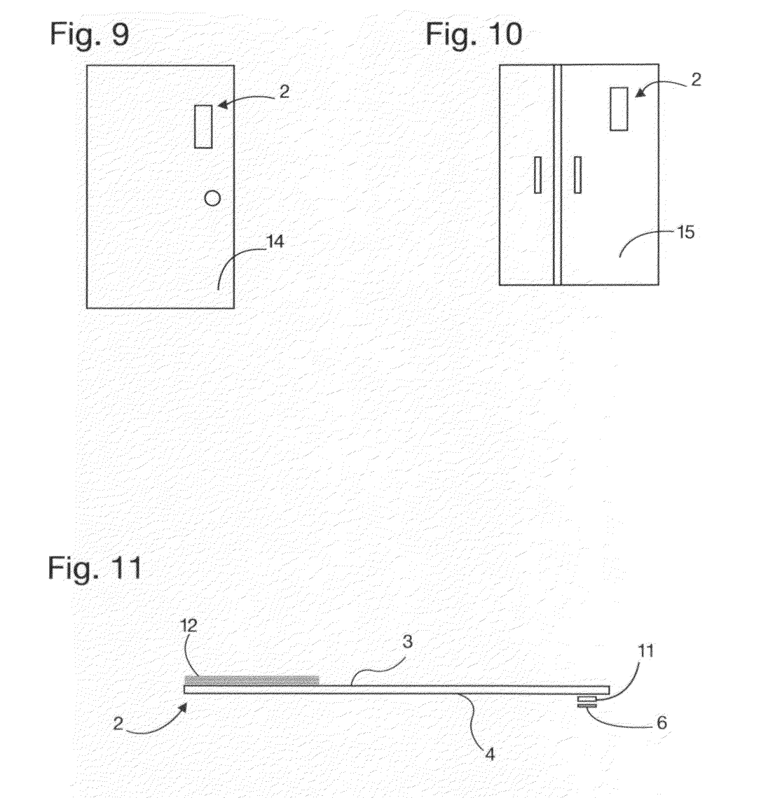

During distribution, liner 6 is peeled away from adhesive 11 and has been removed completely as shown in FIG. 5. Then adhesive 11 is used to attach second planar surface 4 to surface of door 14 or entryway, shown in FIG. 8. First planar surface 3 in FIG. 1 is displayed in full view to the consumer as shown in FIG. 9. Our efficient and effective method for distribution allows hanger 2 to be displayed without unsightly rips or tears associated with standard die-cut doorhangers. Consumer may now peel away hanger 2 from said door 14 and transfer hanger 2 inside of building. Then adhesive 11 is used to attach second planar surface 4 to any surface, including but not limited to plastic, hard surface, glass, wood or metal; such as a refrigerator 15. First planar surface 3 is displayed in full view to the consumer shown in FIG. 10.

Another method of distribution, as shown in FIG. 6, is to peel and fold liner 6 partially or half-way back to expose adhesive 11. Then adhesive 11 is used to attach second planar surface 4 to surface of door 14 or entryway in FIG. 8. First planar surface 3 in FIG. 1 is displayed in full view to the consumer as shown in FIG. 9. Our efficient and effective method for distribution allows hanger 2 to be displayed without unsightly rips or tears associated with standard die-cut doorhangers. Consumer may now peel away hanger 2 from said door 14 and transfer hanger 2 inside of building. Consumer peels away remaining liner 6 to fully expose adhesive. Then adhesive 11 is used to attach second planar 4 to any surface including but not limited to plastic, hard surface, glass, wood or metal; such as refrigerator 15. First planar surface 3 is displayed in full view to the consumer in FIG. 10.

Another method of distribution as shown in FIG. 4 is to have a split liner 7 covering the adhesive 11. Top or bottom part of split liner 7 would be completely removed as shown in FIG. 7 to expose adhesive. Then adhesive 11 is used to attach second planar surface 4 to surface of door or entryway 14 shown in FIG. 8. First planar surface 3 in FIG. 1 is displayed in full view to the consumer as shown in FIG. 9. Our efficient and effective method for distribution allows hanger 2 to be displayed without unsightly rips or tears associated with standard die-cut doorhangers. Consumer may now peel away hanger 2 from said door 14 and transfer hanger 2 inside of building. Consumer peels away remaining liner 6 to fully expose adhesive. Then adhesive 11 is used to attach second planar 4 to any surface including but not limited to plastic, hard surface, glass, wood or metal; such as refrigerator 15. First planar surface 3 is displayed in full view to the consumer in FIG. 10.

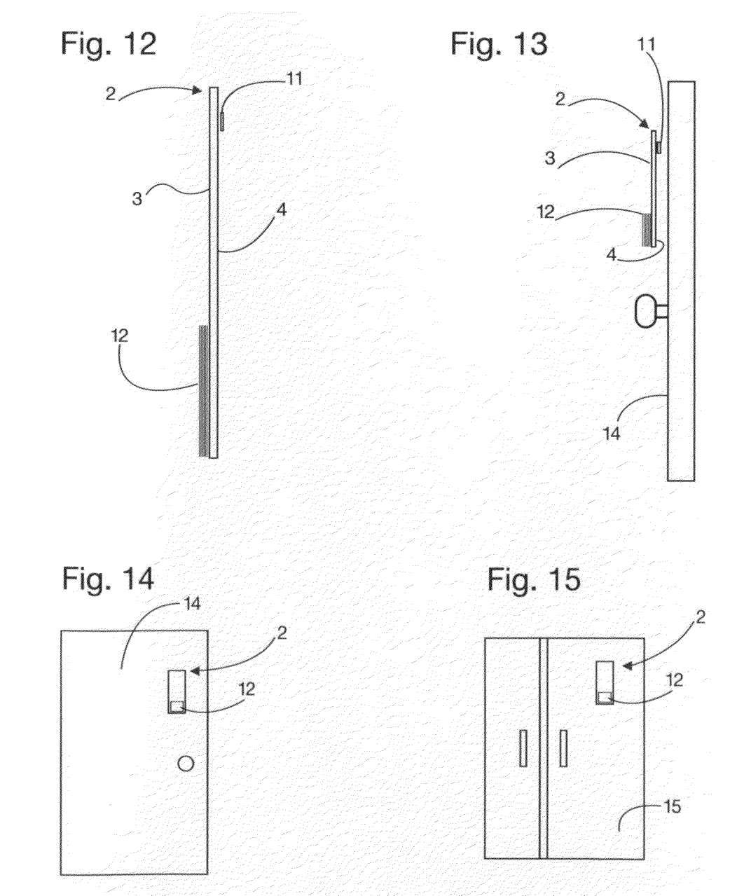

Another method of distribution as shown in FIG. 11 is to have a full liner 6 covering the adhesive 11. Liner 6 would be completely removed as shown in FIG. 12 to expose adhesive. Then adhesive 11 is used to attach second planar surface 4 to surface of door 14 or entryway in FIG. 13. First planar surface 3 in FIG. 1 is displayed in full view to the consumer as shown in FIG. 14. Our efficient and effective method for distribution allows hanger 2 to be displayed without unsightly rips or tears associated with standard die-cut doorhangers. Consumer may now peel away hanger 2 from said door 14 and transfer hanger 2 inside of building. Then adhesive 11 is used to attach second planar 4 to any surface including but not limited to plastic, hard surface, glass, wood or metal; such as refrigerator 15. First planar surface 3 is displayed in full view to the consumer in FIG. 15.

What is claimed is:

1. An advertising piece and presentation article for attaching or mounting to a building, residential dwelling (single or multi family), business or trailer, inside or outside, including but not limited to hallways/corridors, common areas, doors, doorways or entryways, comprising:
A hanger of material or paper of any size, weight, thickness or color, printed with information, advertisement, one coupon or a plurality of coupons.
Hanger can have or not have delineations around said coupons or information, to facilitate removal of said coupons individually from the main body of the said printed piece.

2. An advertising piece and presentation article as defined in claim 1, wherein:
Said coupons can be individually perforated or not perforated (actual or implied), there around to facilitate removal of coupons thereof from said hanger as defined in claim 1; and there may be layers of multiple coupons included in the advertising piece and presentation article.

3. An advertising piece, wherein one side of hanger includes a strip of adhesive with a liner covering the adhesive.
Adhesive could or could not withstand temperatures as high as plus 240 degrees (F.) down to minus 10 degrees (F.).
Said liner could be peeled all the way back or part way back to expose adhesive which could then be used to attach said hanger as defined in claim 1 somewhere on entryway as described in claim 1.
Said liner could be split so as to allow said part of liner to be peeled all of the way back to expose adhesive and then use the exposed adhesive to fasten hanger, as defined in claim 1, to entry way.

4. An advertising piece and presentation article as defined in claim 3, where in hanger could be removed from entryway, as defined in claim 1, and transferred to inside of said building, and attached to any surface, including but not limited to plastic, hard surface, glass, wood, or metal; such as refrigerator, cabinet or computer.
Said part of exposed adhesive as defined in claim 3 could then be peeled from entryway, as defined in claim 1, and transferred to inside of said building, as defined in claim 1. Peel remaining part of liner to expose the rest of the adhesive and attach to any surface, including but not limited to plastic, hard surface, glass, wood, or metal; such as refrigerator, cabinet or computer.
